(19) United States
(12) Patent Application Publication
(10) Pub. No.: US 2023/0027666 A1
(43) Pub. Date: Jan. 26, 2023

(54) RECORDING MOMENTS TO RE-EXPERIENCE

(71) Applicant: Meta Platforms Technologies, LLC, Menlo Park, CA (US)

(72) Inventors: Ashley Gustafson, Surprise, AZ (US); Hilary Hayes, Fremont, CA (US); Ilana Orly Shalowitz, Oakland, CA (US); Ella Mei Yon Biggadike Harris, Belmont, CA (US); Jessica Kitchens, Sacramento, CA (US)

(21) Appl. No.: 17/863,219

(22) Filed: Jul. 12, 2022

Related U.S. Application Data
(60) Provisional application No. 63/221,381, filed on Jul. 13, 2021.

(51) Int. Cl. G06T 19/00; G06F 16/438

(52) U.S. Cl. CPC G06T 19/003; G06T 19/006; G06F 16/4393

(57) ABSTRACT

Methods, systems, and storage media for recording moments as they are occurring and utilizing a virtual assistant to re-play those moments as a fully or partially immersive experience are disclosed. Exemplary implementations may: record data for a particular moment as the moment is occurring and utilize a virtual assistant to replay the moment as a fully or partially immersive experience. The recorded data may include indicators of a plurality of sensory perceptions for the recorded moment.

### CROSS-REFERENCE TO RELATED APPLICATIONS

This present application claims the benefit of priority under 35 U.S.C. § 119(e) to U.S. Provisional Patent Application No. 63/221,381, filed Jul. 13, 2021, the disclosure of which is hereby incorporated by reference in its entirety for all purposes.

### TECHNICAL FIELD

The present disclosure generally relates to recording moments as they are occurring and replaying those moments, for instance, at a later point in time. More particularly, the present disclosure relates to recording data for a particular moment as the moment is occurring, the data including indicators of a plurality of sensory perceptions for the particular moment. The present disclosure further relates to utilizing a virtual assistant to re-play recorded moments as a fully or partially immersive experience.

### BACKGROUND

For decades, people have recorded moments in time via the taking of photographs or recording video of such moments such that the moments may be reviewed or replayed later and/or for other users. In this way, the recordings serve as memory triggers, reminding people of past moments with a level of detail that one's mind may be unable to easily recall through the passage of time. In more recent years, recording technologies have become capable of recording moments in increasing detail. For instance, moments may now be recorded in three dimensions instead of the standard two dimensions of still images and/or video recordings of years past.

### BRIEF SUMMARY

The subject disclosure provides for systems and methods for recording moments as they are occurring and replaying those moments, for instance, at a later point in time in such a way that the moments may be re-experienced or relived in greater fidelity than standard still images and/or video recordings.

One aspect of the present disclosure relates to a computer-implemented method for re-experiencing recorded moments. The method may include recording, by a first device associated with a first user, data for a moment at a first time as the moment is occurring. The data may include indicators of a plurality of sensory perceptions. The plurality of sensory perceptions may include at least one of smell, taste, and touch. The method further may include utilizing a virtual assistant to replay the data for the moment at a second time separate from and later than the first time. The replayed data may include the indicators of the plurality of sensory perceptions. The data may be replayed as at least a partially immersive experience.

Another aspect of the present disclosure relates to a system configured for re-experiencing recorded moments. The system may include one or more hardware processors configured by machine-readable instructions. The processor(s) may be configured to utilize a virtual assistant to initiate recording, by a first device associated with a first user, data for a moment at a first time as the moment is occurring. The data may include indicators of a plurality of sensory perceptions. The plurality of sensory perceptions may include at least one of smell, taste, and touch. The processor(s) further may be configured to utilize the virtual assistant to terminate recording, by the first device associated with the first user, of the data for the moment. The processor(s) further may be configured to utilize the virtual assistant to replay the data for the moment at a second time separate from and later than the first time. The replayed data may include the indicators of the plurality of sensory perceptions. The data may be replayed as at least a partially immersive experience.

Yet another aspect of the present disclosure relates to a non-transient computer-readable storage medium having instructions embodied thereon, the instructions being executable by one or more processors to perform a method for re-experiencing recorded moments. The method may include recording, by a first device associated with a first user, data for a moment at a first time as the moment is occurring. The data may include indicators of a plurality of sensory perceptions. The plurality of sensory perceptions may include at least one of smell, taste, and touch. The method further may include utilizing a virtual assistant to replay the data for the moment at a second time separate from and later than the first time. The replayed data may include the indicators of the plurality of sensory perceptions. The data may be replayed as a sliding scale between a fully immersive experience and a partially immersive experience according to the capabilities of a device on which the data for the moment is replayed.

Still another aspect of the present disclosure relates to a system configured for re-experiencing recorded moments. The system may include means for recording, by a first device associated with a first user, data for a moment at a first time as the moment is occurring. The data may include indicators of a plurality of sensory perceptions. The plurality of sensory perceptions may include at least one of smell, taste, and touch. The system further may include means for utilizing a virtual assistant to replay the data for the moment at a second time separate from and later than the first time. The replayed data may include the indicators of the plurality of sensory perceptions. The data may be replayed as at least a partially immersive experience.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of devices on which some implementations of the disclosed technology can operate.

FIG. 2A is a wire diagram of a virtual reality head-mounted display (HMD), in accordance with one or more implementations of the present disclosure.

FIG. 2B is a wire diagram of a mixed reality HMD system which includes a mixed reality HMD and a core processing component, in accordance with one or more implementations of the present disclosure.

FIG. 3 illustrates a system configured for recording moments as they are occurring and utilizing a virtual assistant to re-experience or relive recorded moments, according to certain aspects of the present disclosure.

FIG. 4 illustrates a flow diagram of an exemplary process for recording moments as they are occurring and utilizing a virtual assistant to re-experience or relive recorded moments, according to certain aspects of the present disclosure.

FIG. 5 illustrates a flow diagram of an exemplary process for recording moments as they are occurring and utilizing a virtual assistant to re-experience or relive recorded moments, according to certain aspects of the present disclosure.

FIG. 6 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

As previously set forth, for decades people have recorded moments in time via the taking of photographs or recording video of such moments such that the moments may be reviewed or replayed later and/or for other users. In this way, the recordings serve as memory triggers, reminding people of past moments with a level of detail that one's mind may be unable to easily recall through the passage of time. In more recent years, recording technologies have become capable of recording moments in increasing detail. For instance, moments may now be recorded in three dimensions instead of the standard two dimensions of still images and/or video recordings of years past.

Technologies of the future may be likely to include a variety of different home devices and wearables that are useful for and capable of recording moments. Such technologies conceivably further may be able to record indicators of sensory perceptions that go beyond the sight and/or sound perceptions of standard still images and/or video recordings. For instance, such technologies may conceivably be capable of recording indicators of sensory perceptions that include other senses, such as smell, taste, and touch. As such, replaying of moments in which a variety of sensory perception indicators have been recorded may permit a user to be more fully immersed in a replayed experience such that it's as though the moment is being re-experienced or relived rather than merely viewed and/or heard.

The subject disclosure provides for a portable virtual assistant that “follows” a user from place-to-place and is consistent among the user's devices. The subject disclosure further provides that the portable virtual assistant may be capable of initiating recording of moments on demand or through contextual awareness. For instance, a user could instruct the virtual assistant: “Hey Assistant, record this moment,” and whatever devices, wearables, or the like that are associated with the user and that are in the vicinity of the user may record the moment. In aspects, the moment may be recorded for a predetermined period of time. In aspects, the moment may be recorded until the user instructs recording to terminate. In aspects, the moment may be recorded until such time that, based upon contextual awareness, the virtual assistant determines that the moment is over. Any and all such variations, and any combination thereof, are contemplated to be within the scope of embodiments of the present disclosure.

The subject disclosure further provides that the portable virtual assistant may be capable of replaying recorded moments according to the capabilities of the device on which replay is requested and/or according to the desires of a user. For instance, in a place and/or time separated from the time of recording of a particular moment, a user may replay that moment in such a way that it's as though the moment is being re-experienced and/or relived rather than merely viewed and/or heard. For example, the user may replay a recorded moment utilizing a virtual reality and/or augmented reality wearable (e.g., headset). By way of example, the user may replay a recorded moment using a hologram, or the like, such that the user could have the experience of actually being physically in the space in which the recorded moment occurred. In aspects, indicators of various sensory perceptions may be recorded and replayed such that the user can re-experience not only the sights and sounds but also, for instance, the smells, the tastes, and/or the physical sensations of the moment.

In aspects, discrete portions or “layers” of a recording may be aligned with the various senses. For instance, there may be a portion or layer of indicators of sensory perceptions for sight, another portion or layer of indicators of sensory perceptions for sound, another portion or layer of indicators of sensory perceptions for smell, another portion of layer of indicators of sensory perceptions for taste, and another portion or layer of indicators of sensory perceptions for physical sensations or touch. In aspects, various layers may be replayed for a user based upon, for instance, the request of a sharing user, the capabilities of the device on which replay is taking place, and/or desires of the user experiencing the replay.

In aspects, replay of recorded moments may be interoperable across devices. For instance, whether a user seeks to replay a moment on a device capable of replaying in two dimensions, three dimensions, utilizing augmented reality, utilizing virtual reality, or the like, the experience may be replayed in accordance with the device capabilities. In aspects, a replayed moment may include a customized experience based upon the device on which replay is taking place. In aspects, a recorded moment may be shared with another user such that the experience is customized in accordance with the capabilities of the receiving device.

In aspects, recordings of a moment taken from different perspectives, either from multiple devices of a single user or devices of multiple users, may be mixed together to generate a re-experience with enhanced detail with respect to any single perspective recorded.

The subject disclosure provides for systems and methods for recording moments (e.g., situations, events, or the like) as they are occurring and utilizing a virtual assistant to re-play those moments as a fully or partially immersive experience. In aspects, data for a particular moment may be recorded utilizing any device known to those having ordinary skill in the art that incorporates at least one camera. By way of example, and not limitation, such devices may include mobile telephones, tablets, smart glasses or goggles, or the like. In aspects, data for a particular moment may be recorded as the particular moment is occurring, the data including indicator(s) of a one or reer sensory perceptions for the particular moment. In aspects, the data may include indicator(s) of sensory perceptions for two or more of sight, sound, smell, taste, and touch. In aspects, the data may include indicator(s) of sensory perceptions for at least one of smell, taste, and touch.

An “immersive experience,” as the term is utilized herein, may be an experience with which a user can engage using a plurality of senses (e.g., any two or more of sight, sound, smell, taste, or touch). In aspects, augmented reality (“AR”) and/or virtual reality (V/R”) technology may be utilized, at least in part, to generate an immersive experience. In aspects, an immersive experience may be enhanced prior to or upon replay. In aspects, as immersive experience may be enhanced utilizing recordings of the moment for which replay is suggested taken from the perspective(s) of one or more additional users. In aspects, a virtual assistant may be utilized to initiate recording of the one or more moments.

In aspects, a virtual assistant may be utilized to replay at a later point in time, a moment for a user from whose perspective the moment was recorded as it was taking place. In aspects, a virtual assistant may be utilized to replay for a second user, a moment recorded from the perspective of a first user, such that the second user may experience the moment either at a later point in time or substantially simultaneously with the first user.

In aspects, a moment may be recorded using one or more stereographic cameras on a wearable device, for instance, to create a volumetrically-mapped three-dimensional space that a user could either enter via an augmented reality overlay, virtual reality, and/or as a sliding scale between augmented and virtual reality. A “stereographic camera” may be a camera having two or more lenses with a separate image sensor for each lens. This allows the camera to simulate human binocular vision, and accordingly permits the capture of three-dimensional images. In aspects, a user may experience or re-experience a recorded moment via, at least in part, an augmented reality overlay. In aspects, a user may experience or re-experience a recorded moment in virtual reality. In aspects, a user may experience or re-experience a recorded moment on a sliding scale with, for instance, one end of the scale permitting a user to experience the moment with only one of the five senses and the other end of the scale permitting a user to experience the moment with all five of the senses. For instance, a user may desire to replay a moment very casually, as a simple reminder of the moment, and accordingly choose to replay the experience on their mobile device as a standard audio/visual rendering. At another point in time, the user may desire to be fully immersed in the recorded moment and choose to replay the moment utilizing AR and/or VR technologies. Any and all such variations, and any combination thereof, are contemplated to be within the scope of embodiments of the present disclosure. In aspects, a virtual assistant may make (or at least aid in making) decisions regarding the fidelity (i.e., defined as the number of sensory perceptions) of a re-played moment taking into account the capabilities of a device with which a user is experiencing the moment.

Embodiments of the disclosed technology may include or be implemented in conjunction with an artificial reality system. Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real-world after they have passed through a computing system. For example, a tablet with a camera on the back can capture images of the real-world and then display the images on the screen on the opposite side of the tablet from the camera. The tablet can process and adjust or “augment” the images as they passthrough the system, such as by adding virtual objects. “Mixed reality” or “MW” refers to systems where light entering a user's eye is partially generated by a computing system and partially composes light reflected off objects in the real world. For example, an MR headset could be shaped as a pair of glasses with a pass-through display, which allows light from the real world to passthrough a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

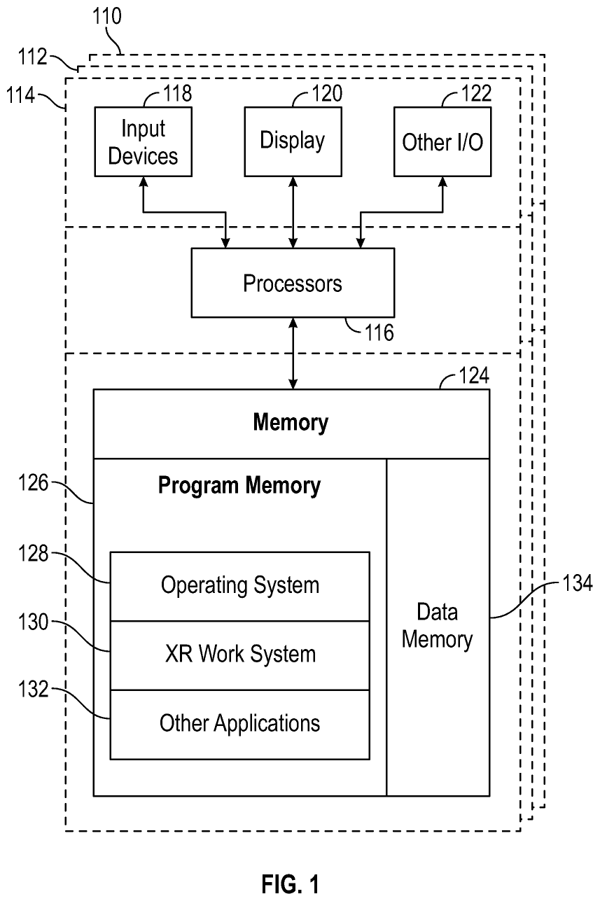

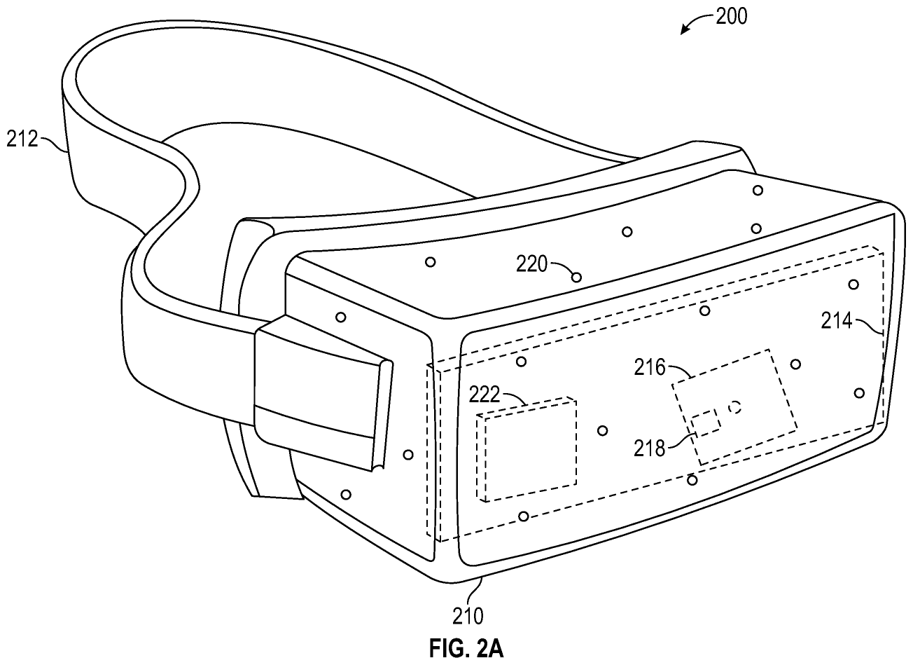

Several implementations are discussed below in more detail in reference to the figures. FIG. 1 is a block diagram illustrating an overview of devices on which some implementations of the disclosed technology can operate. The devices can comprise hardware components of a computing system 100 that can create, administer, and provide interaction modes for an artificial reality collaborative working environment. In various implementations, computing system 100 can include a single computing device 114 or multiple computing devices (e.g., computing device 110, computing device 112, and computing device 114) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data. In some implementations, one or more computing devices 110, 112, 114 may be or include a virtual assistant.

Computing system 100 can include one or more processor(s) 116 (e.g., central processing units (CPUs), graphical processing units (GPUs), holographic processing units (HPUs), etc.) Processors 116 can be a single processing unit or multiple processing units in a device or distributed across multiple devices (e.g., distributed across two or more of computing devices 110, 112, 114).

Computing system 100 can include one or more input devices 118 that provide input to the processors 116, notifying them of actions. The actions can be mediated by a hardware controller that interprets the signals received from the input device and communicates the information to the processors 116 using a communication protocol. Each input device 118 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 116 can be coupled to other hardware devices, for example, with the use of an internal or external bus, such as a PCI bus, SCSI bus, or wireless connection. The processors 160 can communicate with a hardware controller for devices, such as for a display 120. Display 120 can be used to display text and graphics. In some implementations, display 120 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 122 can also be coupled to the processor, such as a network chip or card, video chip or card, audio chip or card, USB, firewire or other external device, camera, printer, speakers, CD-ROM drive, DVD drive, disk drive, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 116 can have access to a memory 124, which can be contained on one of the computing devices of computing system 100 or can be distributed across one of the multiple computing devices of computing system 100 or other external devices. A memory includes one or more hardware devices for volatile or non-volatile storage and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 124 can include program memory 126 that stores programs and software, such as an operating system 128, XR work system 130, and other application programs 132. Memory 124 can also include data memory 134 that can include information to be provided to the program memory 126 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 210 and a band 212. The front rigid body 210 includes one or more electronic display elements of an electronic display 214, an inertial motion unit (IMU) 216, one or more position sensors 218, locators 220, and one or more compute units 222. The position sensors 218, the IMU 216, and compute units 222 may be internal to the HMD 200 and may not be visible to the user. In various implementations, the IMU 216, position sensors 218, and locators 220 can track movement and location of the HMD 200 in the real world and in a virtual environment in three degrees of freedom (3DoF) or six degrees of freedom (6DoF). For example, the locators 220 can emit infrared light beams which create light points on real objects around the HMD 200. As another example, the IMU 216 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 222 in the HMD 200 can use the detected light points to extrapolate position and movement of the HMD 200 as well as to identify the shape and position of the real objects surrounding the HMD 200.

The electronic display 214 can be integrated with the front rigid body 210 and can provide image light to a user as dictated by the compute units 222. In various embodiments, the electronic display 214 can be a single electronic display or multiple electronic displays (e.g., a display for each user eye). Examples of the electronic display 214 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 216 and position sensors 218, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similar to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

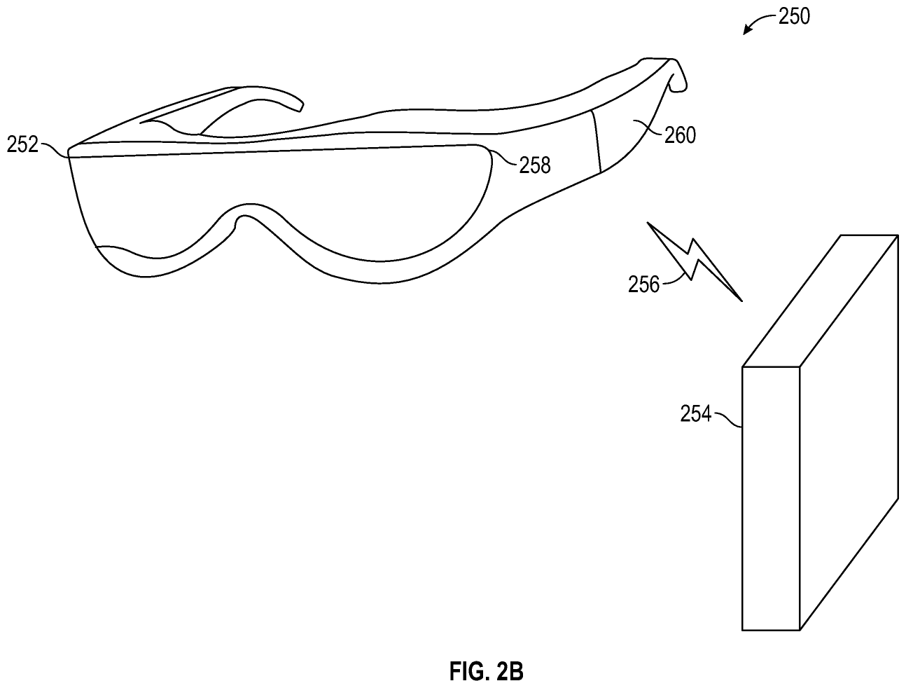

FIG. 3 illustrates a system 300 configured for recording moments (e.g., situations, events, or the like) as they are occurring and utilizing a virtual assistant to re-play those moments as a fully or partially immersive experience, according to certain aspects of the disclosure. In some implementations, system 300 may include one or more computing platforms 310. Computing platform(s) 310 may be configured to communicate with one or more remote platforms 312 according to a client/server architecture, a peer-to-peer architecture, and/or other architectures. Remote platform(s) 312 may be configured to communicate with other remote platforms via computing platform(s) 310 and/or according to a client/server architecture, a peer-to-peer architecture, and/or other architectures. Users may access system 300 via remote platform(s) 312. In some implementations, one or more of computing platform(s) 310 and remote platform(s) 312 may be or include a virtual assistant.

Computing platform(s) 310 may be configured by machine-readable instructions 314. Machine-readable instructions 314 may include one or more instruction modules. The instruction modules may include computer program modules. The instruction modules may include one or more of recording module 316 (including recording initiating component 318, recording terminating component 320, user request receiving component 322, and contextual awareness determining component 324), replaying module 326 (including replay device capability determining component 328), experience generating module 330 (including recording enhancing component 332) and/or other instruction modules.

Recording module 316 may be configured record data for a particular moment as the moment is occurring. In aspects, the data may include indicators of a plurality of sensory perceptions for the particular moment. In aspects, the data may include indicators of sensory perceptions for two or more of sight, sound, smell, taste, and touch. In aspects, the data may include indicators of sensory perceptions for at least one of smell, taste, and touch. In aspects, recording module 316 may be configured to utilize a virtual assistant for recording moments.

As illustrated, recording module 316 includes recording initiating component 318, recording terminating component 320, user request receiving component 322, and contextual awareness determining component 324. Recording initiating component 318 may be configured to initiate recording of a particular moment as it is occurring. Similarly, recording terminating component 320 may be configured to terminate recording of a moment once the moment is complete. Initiating recording and/or terminating recording may be done based upon one or both of a request of a user associated with the device doing the recording (e.g., a request received by user request receiving component 322) or based upon contextual awareness (e.g., contextual awareness determined by contextual awareness determining component 324).

Replaying module 326 may be configured to utilize a virtual assistant to replay recorded data for a particular moment. In aspects, replaying module 326 may be configured to replay a moment in accordance with the capabilities of the device on which replay is being initiated (e.g., as determined by replay device capability determining component 328).

In aspects, replaying module 326 may be configured to utilize a virtual assistant to replay recorded data for a particular moment as a fully or partially immersive experience. In aspects, at least one of augmented reality and virtual reality technology may be utilized to generate a fully or partially immersive experience (e.g., utilizing experience generating component 330). In aspects, experience generating component 330 may be configured to generate replay of a particular moment as a sliding scale between a fully immersive experience and a partially immersive experience. In aspects, the experience generating component 330 may be configured to enhance (e.g., utilizing enhancing component 332) a recorded moment with recordings of the moment taken from different perspectives. In aspects, a different perspective may be provided by a second device of the user that initiated recording of the moment. In aspects, a different perspective may be provided by a device associated with another user that was present as the moment was occurring. Any and all such variations, and any combination thereof, are contemplated to be within the scope of embodiments of the present disclosure.

In some implementations, computing platform(s) 310, remote platform(s) 312, and/or external resources 334 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 310, remote platform(s) 312, and/or external resources 334 may be operatively linked via some other communication media.

A given remote platform 312 may include one or more processors configured to execute computer program modules. The computer program modules may be configured to enable an expert or user associated with the given remote platform 312 to interface with system 300 and/or external resources 334, and/or provide other functionality attributed herein to remote platform(s) 312. By way of non-limiting example, a given remote platform 312 and/or a given computing platform 310 may include one or more of a server, a desktop computer, a laptop computer, a handheld computer, a tablet computing platform, a NetBook, a Smartphone, a gaming console, and/or other computing platforms.

External resources 334 may include sources of information outside of system 300, external entities participating with system 300, and/or other resources. In some implementations, some or all of the functionality attributed herein to external resources 334 may be provided by resources included in system 300.

Computing platform(s) 310 may include electronic storage 336, one or more processors 338, and/or other components. Computing platform(s) 310 may include communication lines, or ports to enable the exchange of information with a network and/or other computing platforms. Illustration of computing platform(s) 310 in FIG. 3 is not intended to be limiting. Computing platform(s) 310 may include a plurality of hardware, software, and/or firmware components operating together to provide the functionality attributed herein to computing platform(s) 310. For example, computing platform(s) 310 may be implemented by a cloud of computing platforms operating together as computing platform(s) 310.

Electronic storage 336 may comprise non-transitory storage media that electronically stores information. The electronic storage media of electronic storage 336 may include one or both of system storage that is provided integrally (i.e., substantially non-removable) with computing platform(s) 310 and/or removable storage that is removably connectable to computing platform(s) 310 via, for example, a port (e.g., a USB port, a firewire port, etc.) or a drive (e.g., a disk drive, etc.). Electronic storage 336 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 336 may include one or more virtual storage resources (e.g., cloud storage, a virtual private network, and/or other virtual storage resources). Electronic storage 336 may store software algorithms, information determined by processor(s) 338, information received from computing platform(s) 310, information received from remote platform(s) 312, and/or other information that enables computing platform(s) 310 to function as described herein.

Processor(s) 338 may be configured to provide information processing capabilities in computing platform(s) 310. As such, processor(s) 338 may include one or more of a digital processor, an analog processor, a digital circuit designed to process information, an analog circuit designed to process information, a state machine, and/or other mechanisms for electronically processing information. Although processor(s) 338 is shown in FIG. 8 as a single entity, this is for illustrative purposes only. In some implementations, processor(s) 338 may include a plurality of processing units. These processing units may be physically located within the same device, or processor(s) 338 may represent processing functionality of a plurality of devices operating in coordination. Processor(s) 338 may be configured to execute modules 316 (including components 318, 320, 322, and 324), 326 (including component 328), 330 (including component 332), and/or other modules. Processor(s) 338 may be configured to execute modules 316 (including components 318, 320, 322, and 324), 326 (including component 328), 330 (including component 332), and/or other modules by software; hardware; firmware; some combination of software, hardware, and/or firmware; and/or other mechanisms for configuring processing capabilities on processor(s) 338. As used herein, the term “module” or “component” may refer to any component or set of components that perform the functionality attributed to the module. This may include one or more physical processors during execution of processor readable instructions, the processor readable instructions, circuitry, hardware, storage media, or any other components.

It should be appreciated that although modules 316 (including components 318, 320, 322, and 324), 326 (including component 328), 330 (including component 332) are illustrated in FIG. 3 as being implemented within a single processing unit, in implementations in which processor(s) 338 includes multiple processing units, one or more of modules 316 (including components 318, 320, 322, and 324), 326 (including component 328), 330 (including component 332) may be implemented remotely from the other modules. The description of the functionality provided by the different modules 316 (including components 318, 320, 322, and 324), 326 (including component 328), 330 (including component 332) described below is for illustrative purposes, and is not intended to be limiting, as any of modules 316 (including components 318, 320, 322, and 324), 326 (including component 328), 330 (including component 332) may provide more or less functionality than is described. For example, one or more of modules 316 (including components 318, 320, 322, and 324), 326 (including component 328), 330 (including component 332) may be eliminated, and some or all of its functionality may be provided by other ones of modules 316 (including components 318, 320, 322, and 324), 326 (including component 328), 330 (including component 332). As another example, processor(s) 338 may be configured to execute one or more additional modules that may perform some or all of the functionality attributed below to one of modules 316 (including components 318, 320, 322, and 324), 326 (including component 328), 330 (including component 332).

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

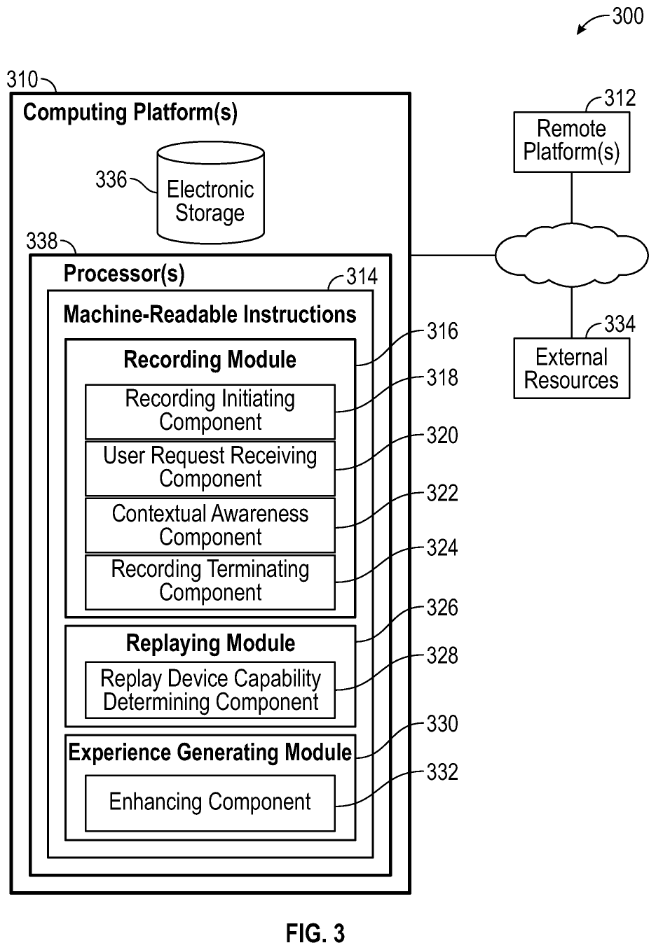

FIG. 4 illustrates an exemplary flow diagram (e.g., process 400) for recording moments (e.g., situations, events, or the like) as they are occurring and utilizing a virtual assistant to re-play those moments as a fully or partially immersive experience, according to certain aspects of the disclosure. For explanatory purposes, the exemplary process 400 is described herein with reference to FIGS. 1, 2A, 2B and 3. Further for explanatory purposes, the steps of the exemplary process 400 are described herein as occurring in serial, or linearly. However, multiple instances of the exemplary process 400 may occur in parallel.

At step 410, the process 400 may include recording data for a particular moment as the moment is occurring, for instance, utilizing the recording module 316 of the system 300 of FIG. 3. In aspects, the data may include indicators of a plurality of sensory perceptions for the particular moment. In aspects, the data may include indicators of sensory perceptions for two or more of sight, sound, smell, taste, and touch. In aspects, the data may include indicators of sensory perceptions for one or more of smell, taste, and touch.

At step 412, the process 400 may include replaying recorded data for a particular moment as a fully or partially immersive experience, for instance, utilizing the replaying module 326 of the system 300 of FIG. 3. In aspects, at least one of augmented reality and virtual reality technology may be utilized to generate a fully or partially immersive experience (e.g., utilizing the experience generating component 330 of the system 300 of FIG. 3). In aspects, replay of a particular moment may be initiated as a sliding scale between a fully immersive experience and a partially immersive experience. In aspects, replay of a particular moment may be initiated in accordance with the capabilities of the device on which replay is being initiated (e.g., as determined by the replay device capability determining component 328 of the system 300 of FIG. 3). In aspects, a recorded moment may be enhanced (e.g., utilizing the enhancing component 332 of the experience generating module 300 of the system 300 of FIG. 3) with recordings of the moment taken from different perspectives. In aspects, a different perspective may be provided by a second device of the user that initiated recording of the moment. In aspects, a different perspective may be provided by a device associated with a second user that was present as the moment was occurring. Any and all such variations, and any combination thereof, are contemplated to be within the scope of embodiments of the present disclosure.

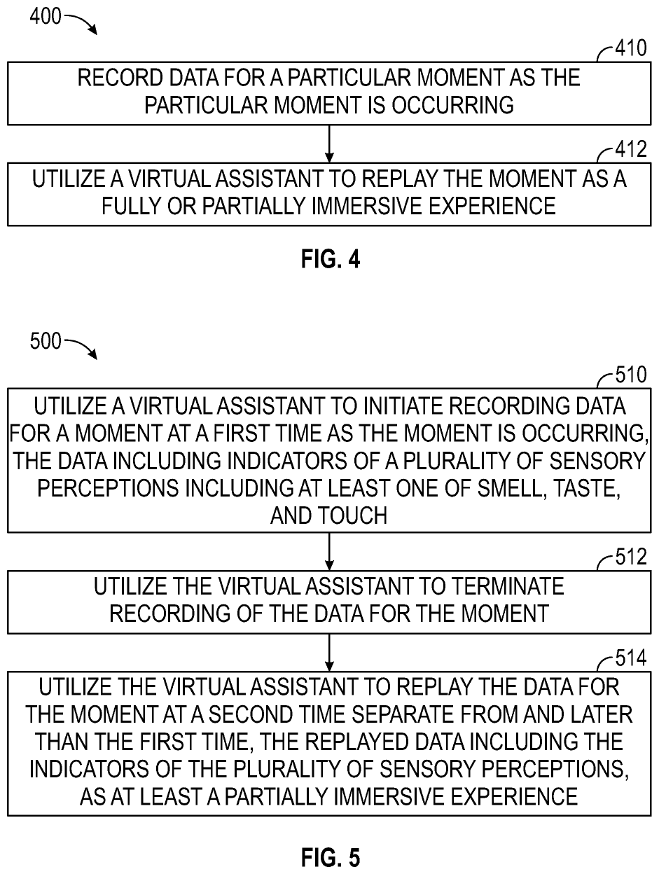

FIG. 5 illustrates an exemplary flow diagram (e.g., process 500) for recording moments (e.g., situations, events, or the like) as they are occurring and utilizing a virtual assistant to re-play those moments as a fully or partially immersive experience, according to certain aspects of the disclosure. For explanatory purposes, the exemplary process 500 is described herein with reference to FIGS. 1, 2A, 2B and 3. Further for explanatory purposes, the steps of the exemplary process 500 are described herein as occurring in serial, or linearly. However, multiple instances of the exemplary process 500 may occur in parallel.

At step 510, the process 500 may include utilizing a virtual assistant to initiate recording (e.g., utilizing the recording initiating component 318 of the recording module 316 of the system 300 of FIG. 3), by a first device associated with a first user, data for a particular moment at a first time as the moment is occurring. In aspects, the data may include indicators of a plurality of sensory perceptions. In aspects, the plurality of sensory perceptions may include at least one of smell, taste, and touch.

At step 512, the process 500 may include utilizing the virtual assistant to terminate recording (e.g., utilizing the recording terminating component 320 of the recording module 316 of the system 300 of FIG. 3), by the first device associated with the first user, of the data for the moment.

At step 514, the process 500 may include utilizing the virtual assistant to replay the data for the moment at a second time separate from and later than the first time (e.g., utilizing the replaying module 326 of the system 300 of FIG. 3). In aspects, the replayed data may include the indicators of the plurality of sensory perceptions, as at least a partially immersive experience (e.g., generated utilizing the experience generating module of the system 300 of FIG. 3).

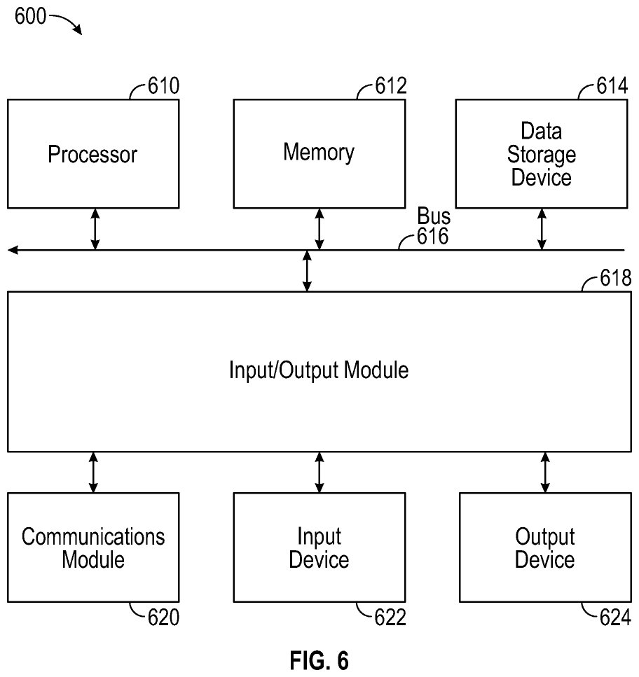

FIG. 6 is a block diagram illustrating an exemplary computer system 600 with which aspects of the subject technology can be implemented. In certain aspects, the computer system 600 may be implemented using hardware or a combination of software and hardware, either in a dedicated server, integrated into another entity, or distributed across multiple entities.

Computer system 600 (e.g., server and/or client) includes a bus 616 or other communication mechanism for communicating information, and a processor 610 coupled with bus 616 for processing information. By way of example, the computer system 600 may be implemented with one or more processors 610. Processor 612 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 600 can include, in addition to hardware, code that creates an execution environment for the computer program in question, e.g., code that constitutes processor firmware, a protocol stack, a database management system, an operating system, or a combination of one or more of them stored in an included memory 612, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 616 for storing information and instructions to be executed by processor 610. The processor 610 and the memory 612 can be supplemented by, or incorporated in, special purpose logic circuitry.

The instructions may be stored in the memory 612 and implemented in one or more computer program products, i.e., one or more modules of computer program instructions encoded on a computer readable medium for execution by, or to control the operation of, the computer system 600, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 610.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 600 further includes a data storage device 614 such as a magnetic disk or optical disk, coupled to bus 616 for storing information and instructions. Computer system 600 may be coupled via input/output module 618 to various devices. The input/output module 618 can be any input/output module. Exemplary input/output modules 618 include data ports such as USB ports. The input/output module 618 is configured to connect to a communications module 620. Exemplary communications modules 620 include networking interface cards, such as Ethernet cards and modems. In certain aspects, the input/output module 618 is configured to connect to a plurality of devices, such as an input device 622 and/or an output device 624. Exemplary input devices 622 include a keyboard and a pointing device, e.g., a mouse or a trackball, by which a user can provide input to the computer system 600. Other kinds of input devices 622 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 624 include display devices such as an LCD (liquid crystal display) monitor, for displaying information to the user.

According to one aspect of the present disclosure, the above-described gaming systems can be implemented using a computer system 600 in response to processor 610 executing one or more sequences of one or more instructions contained in memory 612. Such instructions may be read into memory 612 from another machine-readable medium, such as data storage device 614. Execution of the sequences of instructions contained in the main memory 612 causes processor 610 to perform the process steps described herein. One or more processors in a multi-processing arrangement may also be employed to execute the sequences of instructions contained in memory 612. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 600 can include clients and servers. A client and server are generally remote from each other and typically interact through a communication network. The relationship of client and server arises by virtue of computer programs running on the respective computers and having a client-server relationship to each other. Computer system 600 can be, for example, and without limitation, a desktop computer, laptop computer, or tablet computer. Computer system 600 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 610 for execution. Such a medium may take many forms, including, but not limited to, non-volatile media, volatile media, and transmission media. Non-volatile media include, for example, optical or magnetic disks, such as data storage device 614. Volatile media include dynamic memory, such as memory 612. Transmission media include coaxial cables, copper wire, and fiber optics, including the wires that comprise bus 616. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 600 reads data, information may be read from the data and stored in a memory device, such as the memory 612. Additionally, data from the memory 612 servers accessed via a network the bus 616, or the data storage 614 may be read and loaded into the memory 612. Although data is described as being found in the memory 612, it will be understood that data does not have to be stored in the memory 612 and may be stored in other memory accessible to the processor 610 or distributed among several media, such as the data storage 614.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for re-experiencing recorded moments, the method comprising:
recording, by a first device associated with a first user, data for a moment at a first time as the moment is occurring, the data including indicators of a plurality of sensory perceptions, the plurality of sensory perceptions including at least one of smell, taste, and touch; and
utilizing a virtual assistant to replay the data for the moment at a second time separate from and later than the first time, the replayed data including the indicators of the plurality of sensory perceptions, as at least a partially immersive experience.

2. The computer-implemented method of claim 1, further comprising utilizing the virtual assistant to initiate the recording, by the first device, of the data for the moment at the first time.

3. The computer-implemented method of claim 2, wherein the virtual assistant is utilized to initiate the recording of the data for the moment at at least one of a request of the first user and based upon contextual awareness.

4. The computer-implemented method of claim 2, further comprising utilizing the virtual assistant to terminate the recording, by the first device, of the data for the moment at the first time at at least one of a request of the first user and based upon contextual awareness.

5. The computer-implemented method of claim 1, further comprising generating the at least partially immersive experience utilizing at least one of augmented reality technology and virtual reality technology.

6. The computer-implemented method of claim 1, wherein the virtual assistant replays the data for the moment at the second time as a sliding scale between a fully immersive experience and a partially immersive experience according to the capabilities of a device on which the data for the moment is replayed.

7. The computer-implemented method of claim 1, further comprising enhancing the at least partially immersive experience with additional data for the moment, the additional data being recorded from at least one perspective that is different than a perspective from which the data for the moment is recorded.

8. The computer-implemented method of claim 7, wherein the at least one perspective that is different than the perspective from which the data for the moment is recorded is provided by one or more recordings of the moment recorded by at least one device associated with one or more additional users other than the first user.

9. The computer-implemented method of claim 7, wherein the at least one perspective that is different than the perspective from which the data for the moment is recorded is provided by one or more recordings of the moment recorded by at least a second device associated with the first user.

10. A system configured for re-experiencing recorded moments, the system comprising:
one or more hardware processors configured by machine-readable instructions to:
utilize a virtual assistant to initiate recording, by a first device associated with a first user, data for a moment at a first time as the moment is occurring, the data including indicators of a plurality of sensory perceptions, the plurality of sensory perceptions including at least one of smell, taste, and touch;
utilize the virtual assistant to terminate recording, by the first device associated with the first user, of the data for the moment; and
utilize the virtual assistant to replay the data for the moment at a second time separate from and later than the first time, the replayed data including the indicators of the plurality of sensory perceptions, as at least a partially immersive experience.

11. The system of claim 10, wherein the one or more hardware processors further are configured by the machine-readable instructions to utilize the virtual assistant to initiate the recording of the data for the moment at at least one of a request of the first user and based upon contextual awareness.

12. The system of claim 10, wherein the one or more hardware processors further are configured by the machine-readable instructions to utilize the virtual assistant to terminate the recording of the data for the moment at at least one of a request of the first user and based upon contextual awareness.

13. The system of claim 10, wherein the one or more hardware processors further are configured by the machine-readable instructions to generate the at least partially immersive experience utilizing at least one of augmented reality technology and virtual reality technology.

14. The system of claim 10, wherein the virtual assistant is utilized to replay the data for the moment at the second time as a sliding scale between a fully immersive experience and a partially immersive experience according to the capabilities of a device on which the data for the moment is replayed.

15. The system of claim 10, wherein the one or more hardware processors further are configured by the machine-readable instructions to enhance the at least partially immersive experience with additional data for the moment, the additional data being recorded from at least one perspective that is different than a perspective from which the data for the moment is recorded.

16. A non-transient computer-readable storage medium having instructions embodied thereon, the instructions being executable by one or more processors to perform a method for re-experiencing recorded moments, the method comprising:
recording, by a first device associated with a first user, data for a moment at a first time as the moment is occurring, the data including indicators of a plurality of sensory perceptions, the plurality of sensory perceptions including at least one of smell, taste, and touch; and
utilizing a virtual assistant to replay the data for the moment at a second time separate from and later than the first time, the replayed data including the indicators of the plurality of sensory perceptions, as a sliding scale between a fully immersive experience and a partially immersive experience according to the capabilities of a device on which the data for the moment is replayed.

17. The computer-storage medium of claim 16, wherein the method further comprises:
utilizing the virtual assistant to initiate the recording, by the first device, of the data for the moment at the first time at at least one of a first request of the first user and based upon contextual awareness; and
utilizing the virtual assistant to terminate the recording, by the first device, of the data for the moment at at least one of a second request of the first user and based upon contextual awareness.

18. The computer-storage medium of claim 16, wherein the method further comprises generating the fully or partially immersive experience utilizing at least one of augmented reality technology and virtual reality technology.

19. The computer-storage medium of claim 16, wherein the method further comprises enhancing the fully or partially immersive experience with additional data for the moment, the additional data being recorded from at least one perspective that is different than a perspective from which the data for the moment is recorded.

20. The computer-storage medium of claim 19, wherein the at least one perspective that is different than the perspective from which the data for the moment is recorded is provided by one or more recordings of the same moment taken by at least one of a device associated with a second user and a second device associated with the first user.
